(19) United States
(12) Patent Application Publication
(10) Pub. No.: US 2016/0205895 A1
(43) Pub. Date: Jul. 21, 2016

(54) Tossing Apparatus

(71) Applicants: Pete Anaya, Gibsonton, FL (US); Terri Anaya, Gibsonton, FL (US)

(72) Inventors: Pete Anaya, Gibsonton, FL (US); Terri Anaya, Gibsonton, FL (US)

(21) Appl. No.: 14/959,689

(22) Filed: Dec. 4, 2015

Related U.S. Application Data
(60) Provisional application No. 62/103,651, filed on Jan. 15, 2015.

(51) Int. Cl. A01K 15/02; F41B 3/04

(52) U.S. Cl. CPC A01K 15/025; A01K 15/027; F41B 3/04

(57) ABSTRACT

A tossing apparatus for facilitating the tossing and retrieving of a ball without the user having to physically contact the ball in order to play a game of fetch with a pet. The tossing apparatus includes an elongated tubular barrel having a first end that is open and a second end that tapers so as to form a handle. The tubular barrel comprises a hollow interior volume adapted to hold a ball or similar object therein. The open end of the barrel includes a curved lip, wherein the curved lip is disposed on a portion of the barrel end. In this way, the curved lip is configured to facilitate the retrieval and tossing of a ball supported within the hollow interior of the elongated shaft.

### CROSS REFERENCE TO RELATED APPLICATION

This application claims the benefit of U.S. Provisional Application No. 62/103,651 filed on Jan. 15, 2015. The above identified patent application is herein incorporated by reference in its entirety to provide continuity of disclosure.

### FIELD OF THE INVENTION

The present invention relates to tossing apparatuses. More particularly, the present invention relates to a tossing apparatus that includes a barrel having a handle and an interior volume adapted to support a ball therein. The tossing apparatus is configured to facilitate a game of fetch with a pet without having to physically contact the ball.

### BACKGROUND OF THE INVENTION

Playing fetch is a great way to have fun with your dog and exercise him or her at the same time. However, the pet may want the owner to throw the ball multiple times which may cause the owner's arm to fatigue. This is particularly problematic for elderly pet owners with limited strength and dexterity. As a result, the owner may not wish to throw the ball time and time again and the pet may not receive proper exercise.

Further, the ball may become dirty and wet from rolling on the ground and from the pet retrieving the ball in his or her mouth. If the ball becomes dirty or slimy, the owner may not wish to touch the ball in order to throw the same. If the user touches the ball, his or her hands will become dirty and unsanitary, requiring the user to wash his or her hands. Therefore, there exists a need for a tossing apparatus that allows a user to facilitate the game of fetch without having to physically contact the ball.

Devices have been disclosed in the prior art that relate to ball tossing apparatuses. These include devices that have been patented and published in patent application publications. Some of these devices provide toy baseball bats having a hollow interior adapted to store balls therein. Other devices provide ball tossing apparatuses having arms adapted to receive a ball and a plunger for throwing the ball. These devices, however, fail to provide a tossing apparatus comprising a barrel having an open end with a curved lip thereon configured to facilitate the retrieval and tossing of a ball.

It is therefore submitted that the present invention is substantially divergent in design elements from the prior art, and consequently it is clear that there is a need in the art for an improvement to tossing apparatuses. In this regard, the instant invention substantially fulfills these needs.

### SUMMARY OF THE INVENTION

In view of the foregoing disadvantages inherent in the known types of tossing apparatuses now present in the prior art, the present invention provides a tossing apparatus wherein the same can be utilized for facilitating a game of fetch with a pet.

It is therefore an object of the invention to provide a new and improved tossing apparatus that has all of the advantages of the prior art and none of the disadvantages.

Another object of the present invention is to provide a new and improved tossing apparatus that includes a barrel that tapers towards a handle at an end thereof and that forms a hollow interior.

Yet another object of the present invention is to provide a new and improved tossing apparatus, wherein the barrel includes an opening configured to provide access to the hollow interior thereof.

Still yet another object of the present invention is to provide a new and improved tossing apparatus, wherein the open end of the barrel comprises a curved lip disposed thereon to facilitate scooping the ball into the interior volume of the barrel.

A further object of the present invention is to provide a new and improved tossing apparatus, wherein the curved lip is rounded and includes a central apex configured to facilitate the tossing and retrieving of a ball.

Still yet another object of the present invention is to provide a new and improved tossing apparatus wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the tossing apparatus.

FIG. 2 shows a side cross sectional view of the tossing apparatus.

FIG. 3 shows a perspective view of the tossing apparatus as used to pick up a ball.

FIG. 4 shows a perspective view of the tossing apparatus as used to throw a ball.

### DETAILED DESCRIPTION OF THE INVENTION

Reference is made herein to the attached drawings. Like reference numerals are used throughout the drawings to depict like or similar elements of the tossing apparatus. For the purposes of presenting a brief and clear description of the present invention, the preferred embodiment will be discussed as used for facilitating throwing a ball or other similar object. The figures are intended for representative purposes only and should not be considered to be limiting in any respect.

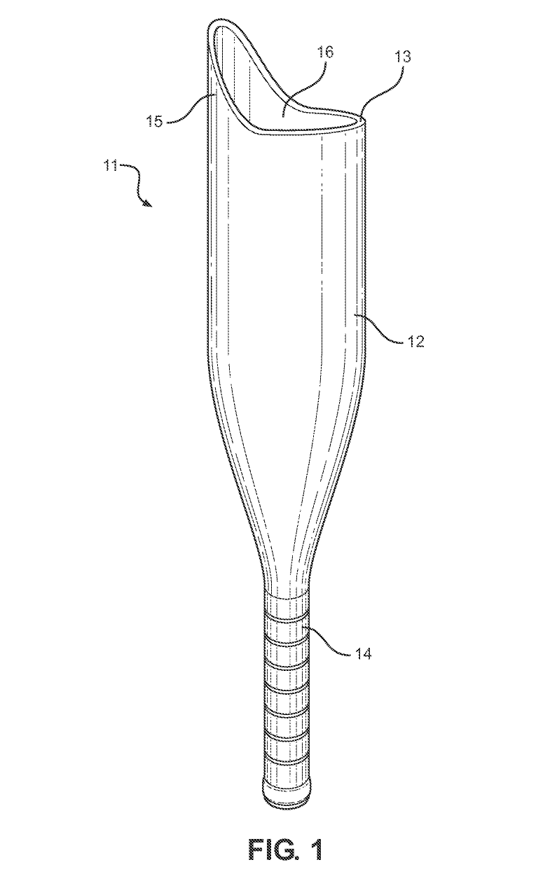

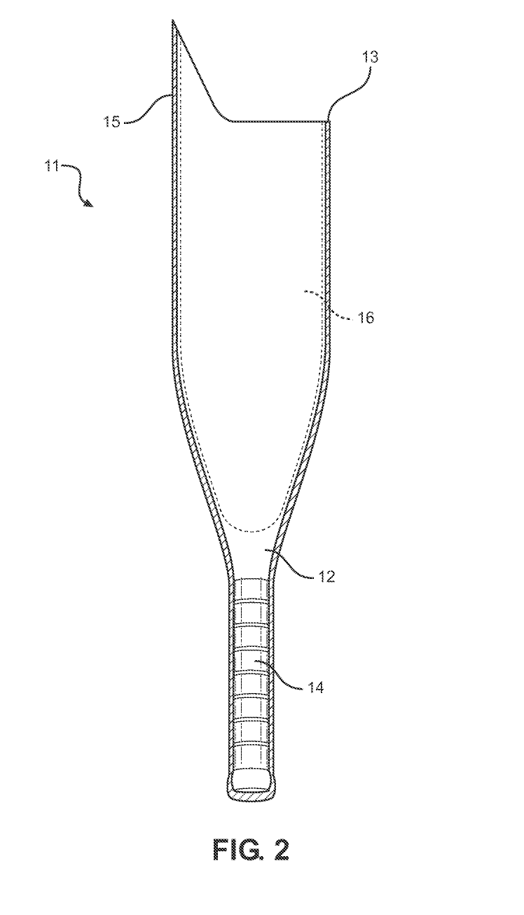

Referring now to FIGS. 1 and 2, there is shown a perspective view and a side cross-sectional view of the tossing apparatus. The tossing apparatus 11 is adapted to allow a user to toss and retrieve or pick up a ball without having to physically contact the ball with his or her hands. This tossing apparatus 11 is particularly useful for playing fetch with a pet.

The tossing apparatus 11 includes an elongated barrel 12 having a hollow interior volume 16. The barrel 12 comprises a substantially tubular construction and includes an open first end 13, a hollow interior volume 16, and a second end 14 that serves as a handle. The barrel 12 is sized so as to receive a ball therein, such as a tennis ball, whiffle ball, or other similar ball. In various embodiments, the barrel 12 is sized so as to fit various specific types of balls and other objects to be thrown.

Preferably, the barrel 12 is cylindrical in shape and tapers along the length thereof towards the second end 14. The barrel 12 tapers towards the second end 14 such that the second end 14 includes a smaller width or diameter than the first end 13 of the barrel 12 so as to serve as a handle. Preferably, the second end 14 is of a diameter or size that allows the user to grasp the second end 14 in one hand. In some embodiments, the second end 14 further comprises a grip composed from rubber or tape to facilitate holding the tossing apparatus 11.

The first end 13 is open so as to allow a ball or other object to be deposited into the interior volume 16 thereof, and to allow a ball to escape from the interior volume thereof. In order to improve the ability to pick up a ball on the ground, the open first end 13 comprises a curved lip 15 on a portion thereof. Preferably, the curved lip 15 extends along approximately half of the open first end 13. The curved lip 15 is preferably rounded such that the lip 15 extends outward from the open first end 13 and includes provides a smooth and continuous surface without any angles. The curved lip 15 is rounded so as to have a U-shape with a central apex.

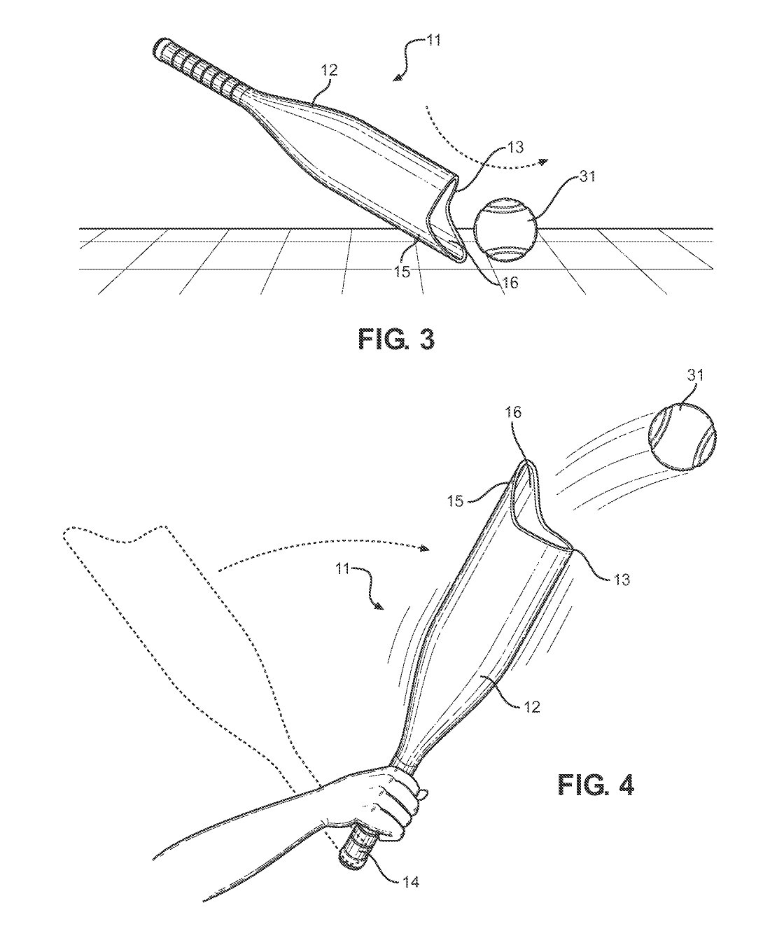

Referring now to FIG. 3, there is shown a perspective view of the tossing apparatus as used to pick up a ball. In operation, a user can hold the second end of the barrel 12 and direct the open end 13 towards a ball 31 on the ground. The user can scoop the ball 31 into the interior volume 16 of the barrel 12 by placing the curved lip 15 underneath the ball 31 so as to cause the ball to enter the barrel 12. In this way, the user can easily pick up or retrieve the ball 31 without having to touch the same. Further, the tossing apparatus 11 provides the user with an extended reach so that the user does not have to fully bend over in order to pick the ball up off of the ground.

Referring now to FIG. 4, there is shown a perspective view of the tossing apparatus as used to throw a ball. Once the ball 31 is held within the interior volume of the barrel 12, the user can then throw the ball directly from the tossing apparatus 11. The user can hold the second end 14 of the barrel 12 and whip his or her wrist in a flicking motion so that the ball 31 is ejected or thrown from the open upper end 13 of the barrel 12. The curved lip 15 helps to direct the ball in a desired direction. Thus, the curved lip 15 provides the user with more control and accuracy when throwing the ball from the tossing apparatus 11. The whipping or flicking motion may be easier for users who cannot throw a ball in the traditional manner and requires less movement of the user's arm. In this way, the tossing apparatus 11 facilitates throwing and retrieving a ball while playing fetch with a pet.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tossing apparatus, comprising:
a tubular barrel having a hollow interior volume, an open first end, and a second end;
wherein the tubular barrel tapers toward the second end so as to form a handle;
a curved lip disposed on the open first end adapted to facilitate scooping a ball into the interior volume of the tubular barrel.

2) The tossing apparatus of claim 1, wherein the tubular barrel comprises a cylindrical configuration.

3) The tossing apparatus of claim 1, wherein the first end of the barrel comprises a larger diameter than that of the second end of the barrel.

4) The tossing apparatus of claim 1, wherein the curved lip comprises a rounded configuration.

5) The tossing apparatus of claim 1, wherein the curved lip forms a smooth and continuous edge on the open first end of the barrel.

6) The tossing apparatus of claim 1, wherein the curved lip comprises a U-shaped configuration.

7) The tossing apparatus of claim 1, wherein the curved lip extends from a portion of the open end of the barrel.
